(19) United States
(12) Patent Application Publication
(10) Pub. No.: US 2026/0081899 A1
(43) Pub. Date: Mar. 19, 2026

(54) DRONE DEVICE, TRAFFIC MANAGEMENT CENTER DEVICE, AND DRONE IDENTIFICATION SECURITY METHOD

(71) Applicant: ELECTRONICS AND TELECOMMUNICATIONS RESEARCH INSTITUTE, Daejeon (KR)

(72) Inventors: Cheol RYU, Daejeon (KR); Do-Hyung Kim, Daejeon (KR); Young-Sae Kim, Daejeon (KR); Yun-Kyung Lee, Daejeon (KR); Jae-Ho Lee, Daejeon (KR); Hyung-Seok Lee, Daejeon (KR); Ye-Seul Choi, Daejeon (KR); Jin-Hee Han, Daejeon (KR)

(21) Appl. No.: 19/325,851

(22) Filed: Sep. 11, 2025

(30) Foreign Application Priority Data
Sep. 13, 2024 (KR) 10-2024-0125490
Sep. 2, 2025 (KR) 10-2025-0123783

(51) Int. Cl. H04L 9/40; G08G 5/26; H04W 4/44; H04W 4/80

(52) U.S. Cl. CPC H04L 63/0442; G08G 5/26; H04W 4/44; H04W 4/80

(57) ABSTRACT

Disclosed herein are a drone device, a traffic management center device, and a drone identification security method. The drone device includes memory configured to store at least one program, a security hardware module configured to generate a public key and a private key, and a processor configured to execute the program, wherein the program is configured to generate a message including a unique identifier, flight status information of the drone device, and neighboring drone information, sign the generated message with the private key through the security hardware module, and transmit the signed message.

### CROSS REFERENCE TO RELATED APPLICATIONS

This application claims the benefit of Korean Patent Application Nos. 10-2024-0125490, filed Sep. 13, 2024 and 10-2025-0123783, filed Sep. 2, 2025, which are hereby incorporated by reference in their entireties into this application.

### BACKGROUND OF THE INVENTION

### 1. Technical Field

The present following embodiments relate to a drone identification and tracking technology.

### 2. Description of the Related Art

With the development and commercialization of drone technology, the use of drones has rapidly increased. However, the rapid proliferation of drones has led to an increase in illegal drone flights. That is, illegal drone flights over airports, military bases, and critical facilities pose a serious threat to public safety, and concerns over terrorist or espionage activities using drones are also growing.

For example, in 2018, at Gatwick Airport in the United Kingdom, drones intruded into the airport's airspace, thus causing hundreds of flights to be canceled or delayed. This incident clearly demonstrates problems caused by the absence of drone identification and tracking systems.

However, it is still not easy to quickly and accurately determine the owner of a drone and the purpose of the drone. That is, currently, multiple drones do not provide unique identification information, and there is a lack of systems that collect and manage drone status information in real time during the flight of the drones.

This situation makes it difficult to identify and track illegal drones, thus posing a significant obstacle to verifying the legitimacy of drone usage. Therefore, threats to public safety attributable to illegal use of drones have increased.

Meanwhile, an Automatic Dependent Surveillance-Broadcast (ADS-B) system is currently used for aircraft identification, in which all aircraft transmit location information using the same frequency. Therefore, if small flying objects such as drones use the ADS-B system on a large scale, frequency congestion may occur. This may pose a major problem especially in urban areas, and may cause signal interference with other aircraft and ground communication systems.

In order to implement drone identification systems, there are several technical challenges to be addressed.

First, an identification module that is reliable while maintaining small sizes and lightweight designs of drones needs to be mounted.

Also, drones should be able to stably perform communication in various environments (such as urban, suburban, and mountainous areas). For this, low-power and long-range communication technologies are required, and technologies such as Long Range (LoRa), Wi-Fi, or Bluetooth are presented as promising alternatives. Further, a communication method using a dedicated frequency may be taken into consideration. This is advantageous for solving a radio congestion problem and guaranteeing stable communication. However, additional cost and efforts are required to secure and manage a dedicated frequency.

Furthermore, to successfully implement drone identification systems, related regulations and standardization are essential. That is, governments and regulatory authorities of respective countries need to establish regulations on drone usage and standards for identification systems, by which both the legitimate use of drones and the prevention of illegal flights may be achieved. When drone identification system standards that can be internationally applied are established, the global operation and management of drones will be more efficiently conducted.

Also, to identify drones, a new protocol that is to supplement an existing communication method is required. This protocol should stably transmit unique identification information of each drone and ensure communication that is reliable in various environments. By means of this, data such as the location, speed, and altitude of each drone may be collected and managed in real time.

Furthermore, to ensure the reliability of the drone identification systems, security acts as an important factor. A security hardware module needs to be used to protect the identification information and location data of each drone. This module provides data encryption, authentication, and integrity verification functions, thus protecting the corresponding system against illegal data manipulation or hacking attempts.

In addition, to effectively implement the drone identification systems, international standardization is essential. Through a standardized protocol and a security module, the global operation and management of drones may be more efficiently performed. Standardization also guarantees compatibility between drone manufacturers and an operator, thus facilitating adoption and proliferation of the system.

### SUMMARY OF THE INVENTION

An embodiment is intended to accurately determine and track the location of a drone in real time through a reliable communication method based on hardware.

An embodiment is intended to effectively prevent threats such as fake drones, transmission of fake identification numbers, and data falsification during transmission so as to prevent illegal drone flights and enhance public safety.

In accordance with an aspect, there is provided a drone device, including memory configured to store at least one program, a security hardware module configured to generate a public key and a private key, and a processor configured to execute the program, wherein the program is configured to generate a message including a unique identifier, flight status information of the drone device, and neighboring drone information, sign the generated message with the private key through the security hardware module, and transmit the signed message.

The unique identifier is generated by hashing the public key.

The flight status information may include at least one of location information, speed information, a heading vector or a timestamp, or a combination thereof.

The program may be configured to submit the public key when the drone device is registered with a traffic management center device.

The program may be configured to unicast a message to a traffic management center device at predetermined intervals.

The program may be configured to broadcast a message at predetermined intervals through short-range wireless communication.

The program may be configured to, as a message broadcasted by at least one additional drone device is received, aggregate a unique identifier of the additional drone device included in the received at least one message to generate neighboring drone information.

The program may be configured to obtain a public key mapped to the unique identifier of the additional drone device from the traffic management center device and verify a signature of the message with the obtained public key to determine whether the message is falsified.

The neighboring drone information may include unique identifier information of an additional drone device that is included in neighboring drones within a predetermined time period, unique identifier information of a neighboring drone device that transmits a signal of a certain magnitude or greater, and unique identifier information of a drone device excluded from neighboring drones within a predetermined time period.

In accordance with another aspect, there is provided a traffic management center device, including memory configured to store at least one program, and a processor configured to execute the program, wherein the program is configured to, as a report message is received from at least one drone device or a land-based base station, verify the received report message with a public key mapped to a unique identifier included in the report message, and to update in real time a database with flight status information of a drone included in the verified report message and neighboring drone information.

The unique identifier may be generated by hashing the public key.

The flight status information may include at least one of location information, speed information, a heading vector or a timestamp, or a combination thereof.

The program may be configured to pre-register a public key submitted by at least one drone device, along with a unique identifier, in a database in response to a registration request from the drone device.

The program may be configured to perform an integrity check using a signature value included in the report message, verify whether the unique identifier is a valid identifier.

The program may verify whether flight status information collected from the report message matches information obtained when flight is authorized.

The program may be configured to cross-verify whether pieces of information collected from at least two report messages match each other.

The program may be configured to, when verification fails, issue a warning while taking a response action.

In accordance with a further aspect, there is provided a drone identification security method, including generating, by a drone device, a message including a unique identifier, flight status information of the drone device, and neighboring drone information, and signing the message generated by the drone device with a private key through a security hardware module, and transmitting a signed message, wherein transmitting the signed message includes unicasting the message to a traffic management center device at predetermined intervals, and broadcasting the message at predetermined intervals through short-range wireless communication.

The unique identifier may be generated by hashing a public key generated through the security hardware module of the drone device, and the flight status information may include at least one of location information, speed information, a heading vector or a timestamp, or a combination thereof.

Generating the message may include, as a message broadcasted by at least one additional drone device is received, aggregating a unique identifier of the additional drone device included in the received at least one message to generate neighboring drone information, wherein the neighboring drone information includes unique identifier information of an additional drone device that is included in neighboring drones within a predetermined time period, unique identifier information of a neighboring drone device that transmits a signal of a certain magnitude or greater, and unique identifier information of a drone device excluded from neighboring drones within a predetermined time period.

The drone identification security method may further include pre-registering, by a traffic management center device, a public key submitted by at least one drone device, along with a unique identifier, in a database in response to a registration request from the drone device, as the traffic management center device receives a report message from at least one drone device or a land-based base station, performing an integrity check using a signature value included in the report message and verifying whether the unique identifier is a valid identifier, determining whether flight status information collected from the report message matches authorized flight plan information, and cross-verifying, by the traffic management center device, whether pieces of information collected from at least two report messages match each other.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic block configuration diagram of a drone identification security system according to an embodiment;

FIG. 2 is a diagram illustrating an example in which a drone is registered with a traffic management center according to an embodiment;

FIGS. 3 to 5 are diagrams illustrating examples of the transmission/reception of messages in a drone identification security system according to an embodiment;

FIG. 6 is a schematic block diagram illustrating the internal configuration of a traffic management center according to an embodiment;

FIG. 7 is a flowchart for explaining a drone identification security method in a drone according to an embodiment;

FIG. 8 is a flowchart for explaining a drone identification security method in a traffic management center according to an embodiment; and FIG. 9 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

The present disclosure relates to a device and method that securely transmit drone identification information and accurately determine and track the location of each drone through the drone identification information. This may prevent threats such as fake drones, transmission of fake identification numbers, and data falsification during transmission by utilizing a reliable communication method based on hardware.

However, it is noted that the present disclosure can be applied to all moving bodies such as a vehicle, aircraft, and a satellite, without being limitedly applied only to drones.

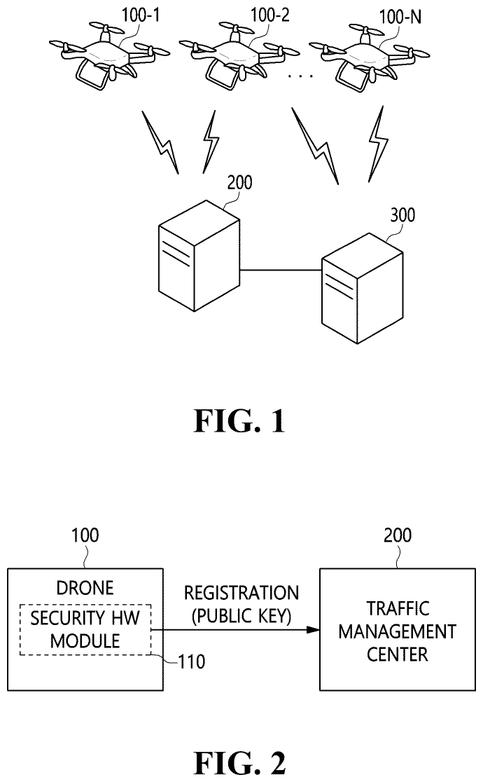

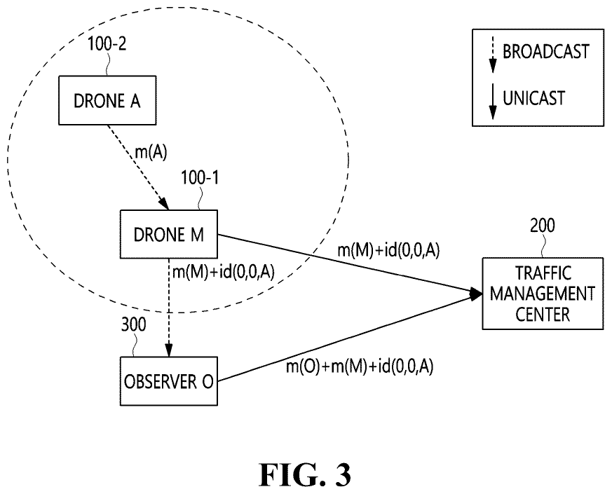

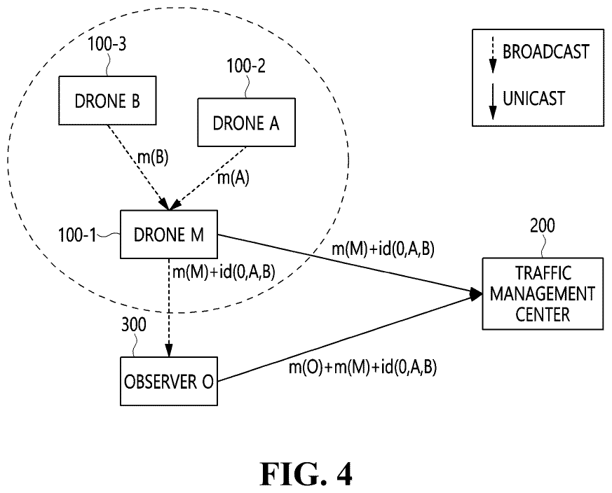

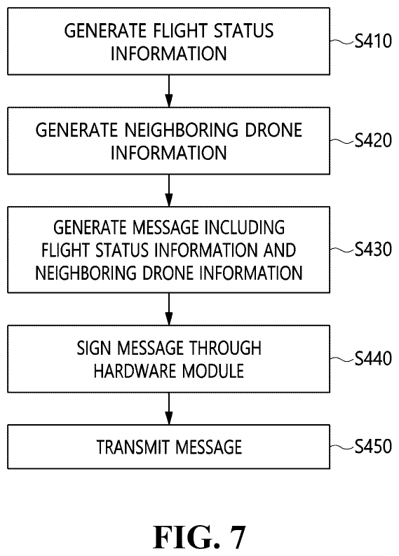

FIG. 1 is a schematic block configuration diagram of a drone identification security system according to an embodiment, FIG. 2 is a diagram illustrating an example in which a drone (also referred to as a ‘drone device’) is registered with a traffic management center according to an embodiment, FIGS. 3 to 5 are diagrams illustrating examples of the transmission/reception of messages in a drone identification security system according to an embodiment, and FIG. 6 is a schematic block diagram illustrating the internal configuration of a traffic management center according to an embodiment.

Referring to FIG. 1, the drone identification security system according to the embodiment may include multiple drones 100-1, 100-2, . . . , 100-N, a traffic management center 200, and an observation device 300.

Referring to FIG. 2, a drone 100 according to the embodiment may be provided with a security hardware (HW) module 110.

Here, the security hardware module 110 may generate a public key and a private key.

Here, a pair of the public key and the private key may be used to guarantee data integrity and security based on a Public Key Infrastructure (PKI).

The drone 100 may submit the public key during registration with the traffic management center 200, thus enabling the public key to be used as a unique identifier. A hash value having a certain length for the public key submitted in this way may be the unique identifier of the drone 100 contained in an actual message in the future.

That is, the unique identifier may be generated by hashing a certain portion divided from the public key. This may be the unique ID of the drone 100, and may be used in all communication and identification processes.

The identifier generation based on hardware may guarantee data integrity and reliability, and may prevent falsification during transmission.

Meanwhile, the drone 100 may transmit a plan for flight to the traffic management center 200 using the unique identifier before flight, and may be issued an authorization number based on the transmitted flight plan from the traffic management center 200.

The authorization number may be used to ensure the legitimacy of flight with the authorization number being contained in a broadcasting message.

Also, the drone 100 may calculate a hash value using the private key with respect to the authorization number and information about the time at which the message is transmitted, and may transmit the hash value along with the message, thus encrypting the authorization number and guaranteeing the integrity thereof.

Further, the drone 100 may generate and transmit a message including the unique identifier, the flight status information of the drone device, and neighboring drone information.

Here, the flight status information may include at least one of location information, speed information, a heading vector, or a timestamp, or a combination thereof.

Furthermore, the neighboring drone information may include a list of neighboring drones that have transmitted messages through short-range wireless communication, that is, a list of identifiers (ID) thereof.

In this case, the message may be signed with the private key through the security hardware module 110, and may then be transmitted. By means of this signature, the message may be ensured not to be falsified during transmission.

This message may be unicasted as a report message to the traffic management center 200 at predetermined intervals.

For example, referring to FIG. 3, a drone 100-1 may transmit a report message containing its own flight status information m(M) and neighboring drone information id(0, 0, A) to the traffic management center 200.

Also, the message may be broadcasted through short-range wireless communication at predetermined intervals.

Here, short-range wireless communication may include Long Range (LoRa), Wi-Fi, and Bluetooth.

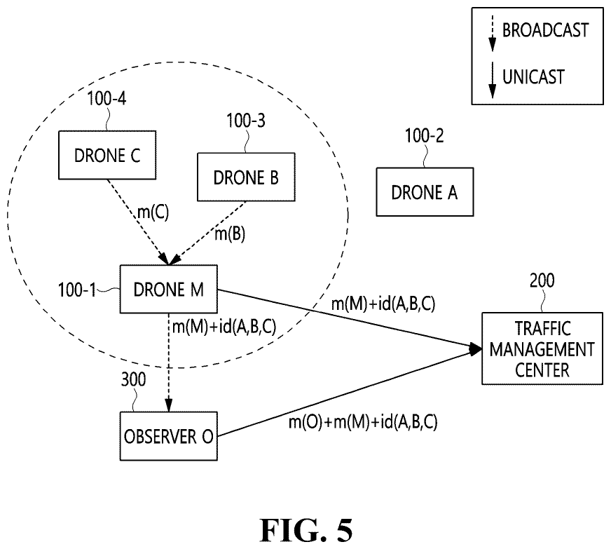

For example, referring to FIG. 4, drones 100-1 and 100-2 may broadcast messages to their surroundings.

Such a broadcasted message may also be received by other nearby devices that enable short-range wireless communication.

Here, the other devices may be other drones or the observation device 300.

Here, the observation device 300 may be a device such as a base station installed on the ground, and may be identified by a unique identifier registered with the traffic management center 200, similar to the drones.

Also, the observation device 300 may transmit the report message to the traffic management center 200.

Here, the report message may include broadcasting messages received from nearby drones, the unique identifier of the relevant drone, and associated information.

The drone 100 and the observation device 300 are always ready to scan broadcasting messages.

Here, the drone 100 and the observation device 300 may be maintained in a ready state in which data is to be received while minimizing power consumption using an efficient protocol.

Meanwhile, as messages broadcasted from other drones are received, the drone 100 may decode the received messages and extract the location information, speed information, heading vectors, and timestamps of the other drones from the decoded messages.

By means of this process, the drone 100 may continuously monitor the locations and speeds of other drones. When a potential collision is detected along a flight path, the drone 100 may calculate a safe evasive maneuver and then adjust the flight path to maintain a safe distance from the other drone devices.

Furthermore, the drone 100 may obtain public keys mapped to the unique identifiers of other drones and verify the signatures of messages using the obtained public keys, thus checking whether the messages are falsified.

Furthermore, as a message broadcasted from at least one additional drone is received, the drone 100 may aggregate the unique identifier of the additional drone included in the received at least one message to generate neighboring drone information.

Here, when the total size of the message is excessively large, it is not efficient, and thus the list of neighboring drones may be summarized to reduce the size of neighboring drone information according to an embodiment.

That is, according to an embodiment, the neighboring drone information may include unique identifier information of an additional drone that is included in neighboring drones within a predetermined time period, unique identifier information of a drone device that transmits a message with a signal of a certain magnitude or greater, and unique identifier information of a drone device excluded from the neighboring drones within a predetermined time period.

For example, as illustrated in FIGS. 3 to 5, unique identifiers of drones may be recorded in three positions denoted by id(1,2,3). Unique identifier information of additional drone devices included in neighboring drones within a predetermined time period, for example, within 1 minute or 5 minutes, may be recorded in position ‘3’. Unique identifier information of drone devices that transmit a message with a signal of a certain magnitude or greater, that is, drone devices expected to still remain as neighboring drones, may be recorded in position ‘2’. Unique identifier information of drone devices excluded from the neighboring drones recently, that is, within a predetermined time period, for example, within 1 minute or 5 minutes, may be recorded in position ‘1’.

That is, referring to FIG. 3, a situation is illustrated in which drone M 100-1 discovers another drone A 100-2. In this case, when drone A 100-2 enters a certain physical range, drone M 100-1 receives a message m(A) broadcasted by drone A 100-2.

Here, drone M 100-1 may transmit neighboring drone information id(0, 0, A), in which the identifier of drone A 100-2 is recorded in position ‘3’ as the unique identifier information of an additional drone most recently included in neighboring drones, while broadcasting its own information m(M).

In addition, referring to FIG. 4, a situation is illustrated in which drone M 100-1 discovers an additional drone B 100-3 in addition to drone A 100-2. In this case, when drone B 100-3 enters a certain physical range, drone M 100-1 additionally receives a message m(B) broadcasted by drone B 100-3 along with the message m(A) broadcasted by drone A 100-2.

Here, drone M 100-1 may transmit neighboring drone information id(0, A, B), in which the identifier of drone B 100-3 is recorded in position ‘3’ as the unique identifier information of an additional drone included in neighboring drones within a predetermined time period and in which the identifier of drone A 100-2 is recorded in position ‘2’ as the unique identifier information of the drone that transmits a message with a signal of a certain magnitude or greater, while broadcasting its own information m(M).

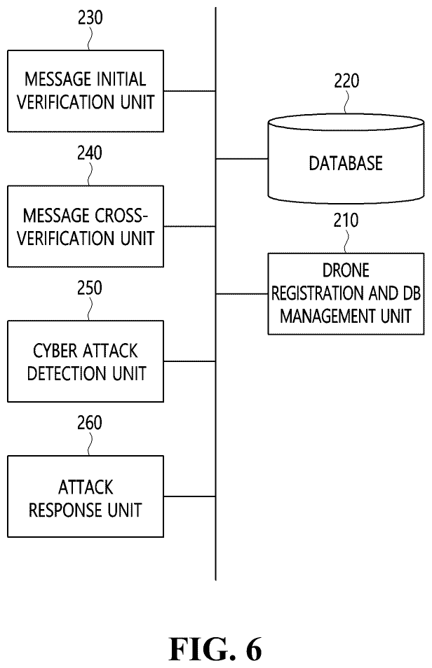

Finally, referring to FIG. 5, a situation is illustrated in which the existing drone A 100-2 deviates from the physical range of drone M 100-1 and discovers an additional drone C 100-4 in addition to the additional drone B 100-3. When drone C 100-4 enters a certain physical range, drone M 100-1 additionally receives a message m(C) broadcasted by drone C 100-4 along with the message m(B) broadcasted by drone B 100-3.

Here, drone M 100-1 may transmit neighboring drone information id(A, B, C), in which the identifier of drone C 100-4 is recorded in position ‘3’ as the unique identifier information of an additional drone included in neighboring drones within a predetermined time period and in which the identifier of drone B 100-3 is recorded in position ‘2’ as the unique identifier information of the drone expected to remain as a neighboring drone, that is, the drone that transmits a signal of a certain magnitude or greater, and in which the identifier of drone A 100-2 is recorded in position ‘1’ as the unique identifier information of a drone excluded from the neighboring drones within a predetermined time period, while broadcasting its own information m(M).

However, the foregoing neighboring drone information, illustrated in FIGS. 3 to 5, is only an embodiment for clear understanding of the present disclosure, and the present disclosure is not limited thereto. For example, each position of the neighboring drone information is implemented in the form of an array, and thus two or more drone unique identifiers may be recorded in each position.

Meanwhile, as a report message is received from at least one drone 100 or the observation device 300, the traffic management center (also referred to as ‘traffic management center device’) 200 according to an embodiment may play an important role in determining and tracking the location of the drone 100 in real time based on data contained in the received report message and in reflecting the current flight status of the drone 100 in the latest database by means of the determined and tracked location.

Referring to FIG. 6, the traffic management center 200 may specifically include a drone registration and database (DB) management unit 210, a database (DB) 220, a message initial verification unit 230, a message cross-verification unit 240, a cyberattack detection unit 250, and an attack response unit 260.

The drone registration and DB management unit 210 may pre-register a public key, submitted by at least one drone 100, along with a unique identifier, in the database 220 in response to a registration request from the drone 100. Also, the drone registration and DB management unit 210 may register a land-based (ground) observation device 300 along with the unique identifier thereof with the database 220.

As a report message is received from the at least one drone 100 or the observation device 300, the message initial verification unit 230 detects a public key mapped to the unique identifier included in the report message from the database 220, and may verify whether or not the report message has been falsified during transmission. For this function, a data integrity check may be performed using a signature value included in the message.

Also, the message initial verification unit 230 may verify whether the unique identifier of the corresponding drone is a pre-registered valid identifier. That is, the unique identifier generated by the security hardware module 110 of the drone 100 may be verified to prevent the use of a fake identifier.

In addition, the message initial verification unit 230 may determine whether flight status information collected from the report message matches authorized flight plan information.

Furthermore, the message cross-verification unit 240 may cross-verify whether pieces of information collected from at least two report messages match each other. That is, whether mutual contradictions are present among pieces of collected information may be verified, and through this verification, the reliability of the data may be evaluated.

For example, whether pieces of location information of the same drone received from different locations in the same time slot match each other may be investigated.

In addition, the message cross-verification unit 240 determines whether the flight path of the drone is a physically feasible path by verifying a heading vector. Abnormal speed variations or impossible flight paths are marked as suspicious targets.

The cyberattack detection unit 250 may apply an algorithm for determining whether a cyberattack is present to the pieces of received information.

Here, abnormality (anomaly) detection algorithms, such as a statistical method and a machine learning technique, may be utilized to detect abnormal data that deviates from the normal range. Furthermore, patterns may be analyzed, so that abnormal patterns may be identified in comparison with past data or so that abnormal data transmission, such as repetitive patterns or patterns concentrated in a specific time span, may be detected.

In this way, the cyberattack detection unit 250 may cross-verify information about the same drone from multiple reception devices, thus enhancing reliability. For example, when suspicious data is received from a specific device, it is possible to check the consistency of data by comparing the received data with data transmitted from another device.

The attack response unit 260 may issue a warning and take response actions when contradictory or suspicious data is detected.

Here, the attack response unit 260 may determine whether the discovered contradictory data is indicative of a cyberattack. For example, whether the contradictory data is intentionally falsified data is determined, and a warning is immediately issued and necessary response actions are taken when the contradictory data is suspected to be a cyberattack.

Here, the response actions may include may include setting of drone flight restriction zones, a request for additional verification, and the like.

Furthermore, the attack response unit 260 may record suspicious data and response actions thereto even when immediate actions are not necessary, thus enabling the recorded data to be used for later analysis and enhancement.

Furthermore, the drone registration and DB management unit 210 may update the database 220 in real time with the flight status information of the drone and the neighboring drone information included in the verified report message.

In this case, the current location and flight direction of the drone are updated in the database 220, but the time information of the received data is recorded to maintain the latest status of the drone.

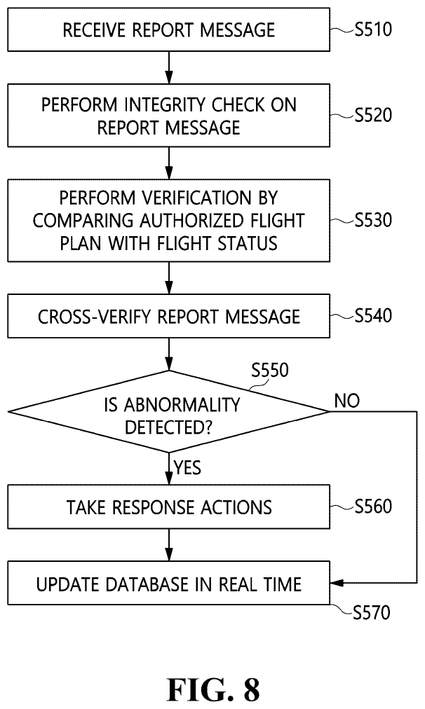

FIG. 7 is a flowchart for explaining a drone identification security method in a drone according to an embodiment.

Referring to FIG. 7, the drone identification security method according to the embodiment may include steps S410 to S430 of generating, by a drone device, a message including a unique identifier, the flight status information of the drone device, and neighboring drone information, and steps S440 and S450 of signing the message generated by the drone device with a private key through a security hardware module and transmitting the signed message.

Further, the drone identification security method according to the embodiment may include the step of submitting a public key when registering the drone device with a traffic management center device.

Here, the unique identifier may be generated by hashing the public key generated by the security hardware module of the drone device.

In addition, the flight status information may include at least one of location information, speed information, a heading vector, or a timestamp, or a combination thereof.

Here, steps S410 to S430 of generating the message may include step S430 of, as a message broadcasted by at least one additional drone device is received, generating neighboring drone information by aggregating the unique identifier of the additional drone device, included in the received at least one message.

Here, the neighboring drone information may include unique identifier information of additional drones that are included in neighboring drones within a predetermined time period, unique identifier information of drone devices that transmit a signal of a certain magnitude or greater, and unique identifier information of drone devices excluded from neighboring drones within a predetermined time period.

Furthermore, the transmitting step S450 may include the step of unicasting a message to the traffic management center device at predetermined intervals and the step of broadcasting the message at predetermined intervals through short-range wireless communication.

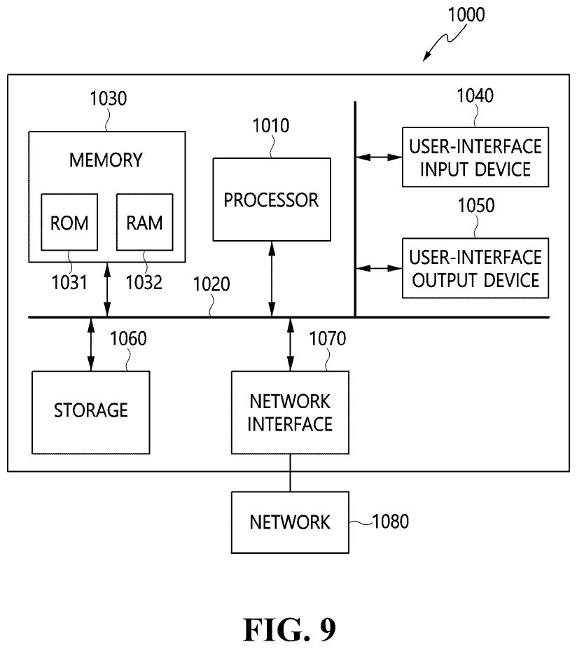

FIG. 8 is a flowchart for explaining a drone identification security method in a traffic management center according to an embodiment.

Referring to FIG. 8, the drone identification security method according to the embodiment may include step S520 of, as the traffic management center device receives a report message from at least one drone device or a land-based base station at step S510, performing an integrity check using a signature value included in the report message, and verifying whether a unique identifier is a valid identifier, step S530 of determining whether flight status information collected from the report message matches authorized flight plan information, and step S540 of cross-verifying, by the traffic management center device, whether pieces of information collected from at least two report messages match each other.

Here, the drone identification security method according to the embodiment may further include the step of pre-registering, by the traffic management center device, a public key submitted by at least one drone device, along with the unique identifier, in a database (DB) in response to a registration request from the drone device.

Furthermore, the drone identification security method according to the embodiment may further include step S560 of taking response actions while issuing a warning when contradictory or suspicious data is detected by the traffic management center device at step S550.

Here, whether the detected contradictory data is indicative of a cyberattack may be determined. For example, whether the contradictory data is intentionally falsified data is determined, and a warning is immediately issued and necessary response actions are taken when the contradictory data is suspected to be a cyberattack.

Here, the response actions may include may include setting of drone flight restriction zones, a request for additional verification, and the like.

Furthermore, suspicious data and response actions thereto may be recorded even when immediate actions are not necessary, thus enabling the recorded data to be used for later analysis and enhancement.

Furthermore, the drone identification security method according to the embodiment may further include step S570 of updating, by the traffic management center device, the database with the flight status information of the drone and the neighboring drone information that are included in the verified report message in real time.

In this case, the current location and flight direction of the drone are updated in the database, but the time information of the received data may be recorded to maintain the latest status of the drone.

FIG. 9 is a diagram illustrating the configuration of a computer system according to an embodiment.

At least one of a drone 100, a traffic management center 200, or an observation device 300, or a combination thereof may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to embodiments, the location of a drone may be accurately determined and tracked in real time through a reliable communication method based on hardware.

According to embodiments, threats such as fake drones, transmission of fake identification numbers, and data falsification during transmission may be effectively prevented so as to prevent illegal drone flights and enhance public safety.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the scope of the present disclosure.

What is claimed is:

1. A drone device, comprising:
a memory configured to store at least one program;
a security hardware module configured to generate a public key and a private key; and
a processor configured to execute the program,
wherein the program is configured to generate a message including a unique identifier, flight status information of the drone device, and neighboring drone information, sign the generated message with the private key through the security hardware module, and transmit the signed message.

2. The drone device of claim 1, wherein the unique identifier is generated by hashing the public key generated by the security hardware module.

3. The drone device of claim 1, wherein the flight status information includes at least one of location information, speed information, a heading vector or a timestamp, or a combination thereof.

4. The drone device of claim 1, wherein the program is configured to submit the public key generated by the security hardware module when the drone device is registered with a traffic management center device.

5. The drone device of claim 1, wherein the program is configured to unicast an integrity-verified message to a traffic management center device at predetermined intervals.

6. The drone device of claim 1, wherein the program is configured to broadcast an integrity-verified message at predetermined intervals through short-range wireless communication.

7. The drone device of claim 1, wherein the program is configured to, as a message broadcasted by at least one additional drone device is received, aggregate a unique identifier of the additional drone device included in the received at least one message to generate neighboring drone information.

8. The drone device of claim 7, wherein the program is configured to obtain a public key mapped to the unique identifier of the additional drone device from the traffic management center device and verify a signature of the message with the obtained public key to determine whether the message is falsified.

9. The drone device of claim 7, wherein the neighboring drone information includes unique identifier information of an additional drone device that is included in neighboring drones within a predetermined time period, unique identifier information of a drone device that transmits a message with a signal of a certain magnitude or greater, and unique identifier information of a drone device excluded from neighboring drones within a predetermined time period.

10. A traffic management center device, comprising:
a memory configured to store at least one program; and
a processor configured to execute the program,
wherein the program is configured to, as a report message is received from at least one drone device or a land-based base station, verify the received report message with a public key mapped to a unique identifier included in the report message, and to update in real time a database with flight status information of a drone included in the verified report message and neighboring drone information.

11. The traffic management center device of claim 10, wherein the unique identifier is generated by hashing the public key.

12. The traffic management center device of claim 10, wherein the flight status information includes at least one of location information, speed information, a heading vector or a timestamp, or a combination thereof.

13. The traffic management center device of claim 10, wherein the program is configured to pre-register a public key submitted by at least one drone device, along with a unique identifier, in a database in response to a registration request from the drone device.

14. The traffic management center device of claim 10, wherein the program is configured to perform an integrity check using a signature value included in the report message, verify whether the unique identifier is a valid identifier, and determine whether flight status information collected from the report message matches authorized flight plan information.

15. The traffic management center device of claim 10, wherein the program is configured to cross-verify whether pieces of information collected from at least two report messages match each other.

16. The traffic management center device of claim 10, wherein the program is configured to, when cross-verification fails, issue a warning while taking a response action.

17. A drone identification security method, comprising:
generating, by a drone device, a message including a unique identifier, flight status information of the drone device, and neighboring drone information; and
signing the message generated by the drone device with a private key through a security hardware module, and transmitting a signed message,
wherein transmitting the signed message comprises:
unicasting the message to a traffic management center device at predetermined intervals; and
broadcasting the message at predetermined intervals through short-range wireless communication.

18. The drone identification security method of claim 17, wherein:
the unique identifier is generated by hashing a public key generated by the security hardware module of the drone device, and
the flight status information includes at least one of location information, speed information, a heading vector or a timestamp, or a combination thereof.

19. The drone identification security method of claim 17, wherein generating the message comprises:
as a message broadcasted by at least one additional drone device is received, aggregating a unique identifier of the additional drone device included in the received at least one message to generate neighboring drone information,
wherein the neighboring drone information includes unique identifier information of an additional drone device that is included in neighboring drones within a predetermined time period, unique identifier information of a drone device that transmits a message with a signal of a certain magnitude or greater, and unique identifier information of a drone device excluded from neighboring drones within a predetermined time period.

20. The drone identification security method of claim 17, further comprising:
pre-registering, by a traffic management center device, a public key submitted by at least one drone device, along with a unique identifier, in a database in response to a registration request from the drone device;
as the traffic management center device receives a report message from at least one drone device or a land-based base station, performing an integrity check using a signature value included in the report message and verifying whether the unique identifier is a valid identifier;
determining whether flight status information collected from the report message matches authorized flight plan information; and
cross-verifying, by the traffic management center device, whether pieces of information collected from at least two report messages match each other.
